(19) United States
(12) Patent Application Publication
(10) Pub. No.: US 2009/0291410 A1
(43) Pub. Date: Nov. 26, 2009

(54) DENTAL DELIVERY UNIT ACCESSORIES

(76) Inventor: Mark G. Conners, Pittsford, NY (US)

Correspondence Address: HISCOCK & BARCLAY, LLP, 2000 HSBC PLAZA, 100 Chestnut Street, ROCHESTER, NY, 14604-2404, US

(21) Appl. No.: 12/484,932

(22) Filed: Jun. 15, 2009

Related U.S. Application Data
(63) Continuation-in-part of application No. 10/889,284, filed on Jul. 12, 2004.

(51) Int. Cl. A61C 17/022; A61C 19/00

(52) U.S. Cl. 433/50; 433/80

(57) ABSTRACT

Disclosed in this specification is a cradle switch plug that is placed into a cradle of a dental instrument in a dental delivery unit to deactivate the instrument thereby allowing the instrument to remain at the ready without endangering or spraying the user and/or assistants and/or patients. In addition, when an instrument is removed from an air fitting a plug may be screwed into the air fitting. The plug prevents entry of debris into the ports thereof. The plug also enables proper seating of the air fitting within the cradle and, thus, actuation of the cradle switch.

### CROSS-REFERENCE TO RELATED APPLICATIONS

This application claims is a continuation-in-part of co-pending U.S. patent application Ser. No. 10/889,284, filed Jul. 12, 2004, which application is incorporated herein by reference in its entirety.

### FIELD OF THE INVENTION

This invention relates, in one embodiment, to machines used in dentistry. More specifically, embodiments of the present invention relate to accessories for disabling dental air-powered tools, such as drills and the like, without requiring replacement of the tools in their cradles or leaving the hoses open to contamination.

### BACKGROUND OF THE INVENTION

Embodiments relate to improvements in a dental delivery unit. In particular, the present invention provides a cradle switch plug for activating a cradle switch in a dental tool holder. Generally, the cradle switch plug activates the cradle switch to thereby disable an instrument without that instrument being disposed within the cradle, such as an instrument that is only temporarily not being used but which, for a variety of reasons, the user does not wish to return to the cradle. Additionally, embodiments provide a threaded air fitting cap that covers the open end, i.e., the air fitting, of an unused air supply hose and which is configured or shaped to enable (or not interfere with) the proper seating of the air fitting within the cradle and activation of the cradle switch to disconnect the hose from or deactivate the supply of pressurized air to the hose. Alternatively, embodiments can employ a combination of a cradle switch plug and a threaded air fitting cap to provide both functions.

Typical dental delivery units, such as that shown in U.S. Pat. No. 6,419,487, include a source of motive fluid, such as compressed air, to which at least one hose is attached. The hose leads and provides motive fluid to a tool, such as a turbine drill, that a dentist or dental assistant uses to work on a patient's teeth. The hose can also carry exhaust motive fluid, can supply water and air for irrigation and other purposes, and provide a fiber optic conduit, among other items, depending on the particular features desired by the end user. Typically, a switch such as a foot pedal, enables and controls the amount of power used by the tool. Additionally, a tool holder preferably includes a “kill switch” or cradle switch that shuts off the supply of motive fluid to the tool when it rests in its cradle and activates the switch. A plurality of hoses is included in most dental delivery units, each hose with its own respective cradle and corresponding cradle switch. The cradle “kill switches” allow power to travel to their respective hoses until the hoses are returned to their cradles thereby activating the switch.

Upon occasion, the user will need to have one tool handy while using a second tool and will set the first tool down. Because the cradle switches allow power to travel to their hoses until they are returned to their cradles, both tools will continue to receive power in this scenario. Thus, when the second tool is used, the first will also be activated spraying people and objects or worse. Thus, there is a need for away to readily turn off power to a dental tool without replacing it in its holder.

The tools on the hoses of a delivery unit are typically interchangeable. When a tool is removed from its hose, the end of the hose is exposed, leaving any ports, such as air supply and exhaust ports, vulnerable to debris and other non-sterile material that could, among other things, infect the patient. Thus, there is a need for an easy way to keep debris and/or other non-sterile material from entering the ports on an end of such hoses.

Embodiments provide a cradle switch plug that fits into a hose cradle, interacting with its kill switch to turn off power to the respective hose. Thus, if the user wants to use a second tool without replacing the first tool in its cradle or removing it from its hose, the user simply places the plug in the cradle to deactivate the tool.

Embodiments also provide a threaded blind air fitting cap for a dental delivery air hose. When a tool is removed from its hose, the cap can be screwed on in its place to prevent material from entering ports in the end of the hose and to enable the air fitting to activate the cradle switch to thereby deactivate the hose.

Embodiments Her provide for a combined cradle switch plug and cap in which one end of a cylinder is shaped as the cradle switch plug and the other is threaded to fit on the end of an air fitting. Alternatively, the cradle switch plug can include threads into which the cap can be screwed so that when the user wishes to use the cap, he or she unscrews the cap from the cradle switch plug, then screws the cap onto the end of the air fitting.

The above and other features of the present invention, as well as the structure and operation of preferred embodiments of the present invention, are described in detail below with reference to the accompanying drawings.

### SUMMARY OF THE INVENTION

The invention comprises, in one form thereof a dental apparatus with an air fitting and a cap. The air fitting has a narrow and a wide portion and a frustoconical portion connecting the two. The hose also includes several ports for transporting motive fluids through the air fitting. The cap attaches to the wide portion and prevents debris from contaminating the air fitting and the hoses connected thereto. The cap can be easily removed and a dental instrument attached to the air fitting in its place.

### BRIEF DESCRIPTION OF THE DRAWINGS

The present invention is disclosed with reference to the accompanying drawings, wherein:

FIG. 1 shows a typical dental delivery unit with which embodiments can be used;

FIG. 2 shows a typical dental delivery unit tool support with five cradles with which embodiments can be used;

FIG. 3 is a schematic diagram showing a cradle switch plug according to embodiments;

FIG. 4 is a schematic diagram showing a blind air fitting plug according to embodiments;

FIG. 5A is a schematic plan diagram of an air fitting with which embodiments can be used and showing ports in the end of the hose;

FIG. 5B is a semi-transparent side view of an air fitting plug;

FIG. 6 is a schematic diagram of an air fitting and a cap according to embodiments; the cap not being screwed onto the air fitting;

FIG. 7 is a schematic diagram of an air fitting and a cap according to embodiments, the cap being partially screwed onto the air fitting; and

FIG. 8 is a schematic diagram of another air fitting and a cap according to embodiments, the cap being fully screwed onto the air fitting.

Corresponding reference characters indicate corresponding parts throughout the several views. The examples set out herein illustrate several embodiments of the invention but should not be construed as limiting the scope of the invention in any manner.

### DETAILED DESCRIPTION OF A PREFERRED EMBODIMENT

While the present invention may be embodied in many different forms, there is described herein in detail an illustrative embodiment with the understanding that the present disclosure is to be considered as an example of the principles of the invention and is not intended to limit the invention to the illustrated embodiment.

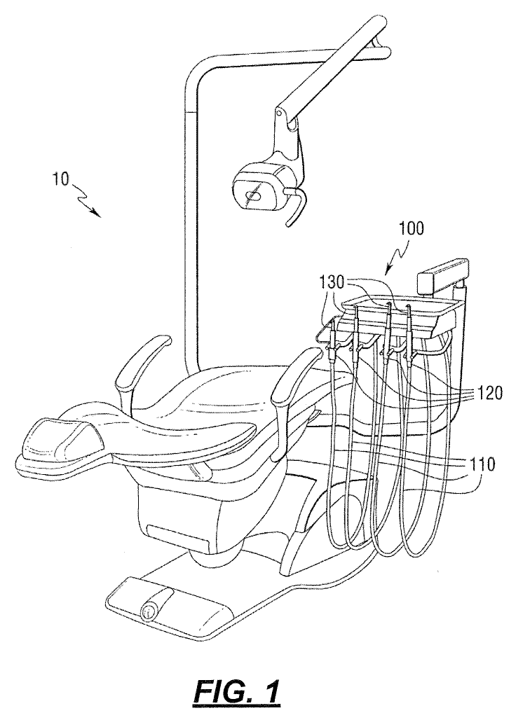

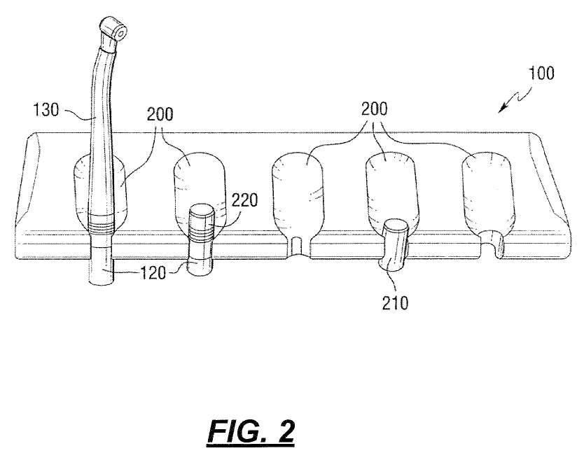

Typical dental delivery units, such as that shown in U.S. Pat. No. 6,419,487, include a source of motive fluid, such as compressed air, to which at least one hose is attached. See FIG. 1, which shows atypical delivery unit 10 with a tray 100 supporting a plurality of hoses 110 that end in air fittings 120 to which are attached instruments or tools 130. Each hose 110 leads and provides motive fluid to a tool 130, such as a turbine drill, that a dentist or dental assistant uses to work on a patient's teeth. The hoses 110 can also carry exhaust motive fluid, can supply water and air for irrigation and other purposes, and provide a fiber optic conduit, among other items, depending on the particular features desired by the end user. Typically, a switch (not shown), such as a foot pedal, enables and controls the amount of power used by the tool 130. Additionally, a tool holder or cradle 200 (see FIG. 2) in the tray 100 preferably includes a “kill switch” (not shown) such that motive fluid is not sent to the tool 130 when it rests in its cradle 200. Each instrument 130 generally has its own respective cradle 200. The cradle “kill switches” allow power to travel to their respective tools 130 until they are returned to their cradles 200.

To enable a user to have one tool handy while using a second tool without power going to the first tool, embodiments provide a cradle switch plug 210. The switch plug 210 fits into a cradle 200, interacting with its kill switch to turn off power to the respective hose 110 and tool 130. Thus, if the user wants to use a second tool without replacing the first tool in its cradle or removing it from its hose, the user simply places the switch-plug in the cradle to deactivate the tool.

To ensure proper functioning, the switch plug 210 preferably has a contour substantially identical to that of an air fitting 120 on the hose 110 and to which the tool 130 is attached. Additionally, the switch plug 210 must be of sufficient weight to activate the kill switch of the cradle 200. Furthermore, the switch plug 210 must be constructed of a material, or with a finish, that is easily cleaned, sterilized, durable, and resistant to corrosion and fluids.

Preferably, embodiments use stainless steel as the primary material for the switch plug 210, thus providing adequate weight and substantially eliminating corrosion of the switch plug 210. Although in the embodiment shown and described the switch plug 210 is preferably constructed of stainless steel, it is to be understood that the switch plug 210 of the present invention can be alternately configured and constructed of other suitable materials having the described characteristics, such as, for example, other metals, weighted or heavier plastics, or from any other suitable material or with a finish that is easily cleaned, sterilized, durable, and resistant to corrosion and fluids.

Yet another alternative is to package or enclose the plug 210 in a sterilized package or packaging material that is replaced and/or disposed of after each use.

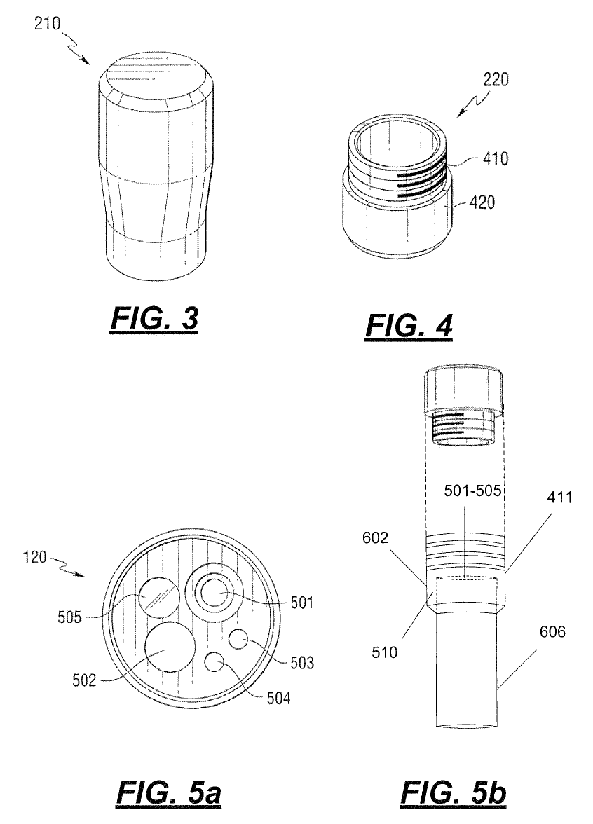

The tools on the hoses of a delivery unit are typically interchangeable. When a tool 130 is removed from its hose, the end of the hose 110 or its air fitting 120 is exposed. See FIG. 5A. Embodiments contemplate a cap 220 (see FIG. 4) that threads onto the air fitting 120 and has a contour configured that enables (or does not interfere with) proper seating of the hose/air fitting in the cradle and, thus, the activation of the cradle switch. The cap 220, of course, must be of sufficient weight to activate the kill switch of the cradle.

An example of a cap 220 according to embodiments is shown in FIGS. 2, 4 and 6-8.

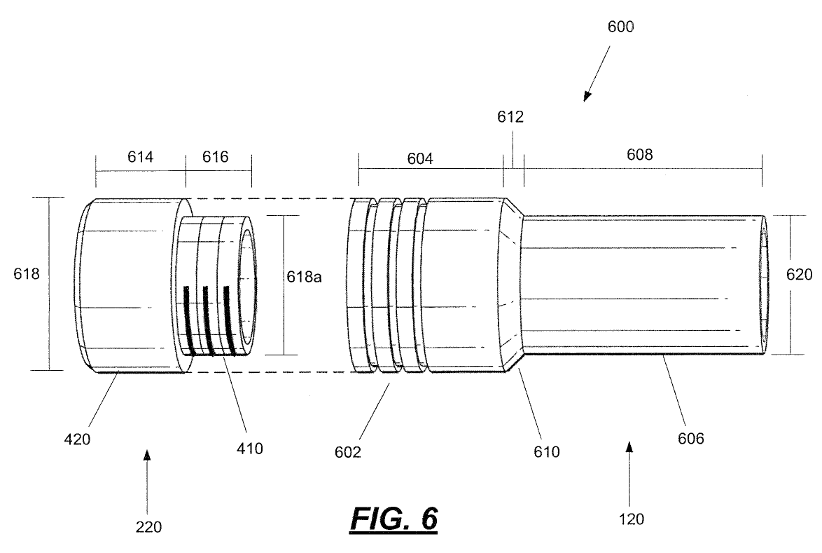

FIG. 5A shows an example of an end of an air fitting 120 and the end of hose 110 including separate ports, such as air supply port 501 and exhaust port 502, as well as water supply 503, spray air supply 504, and fiber optic conduit 505. By supplying separate ports, different fluids, such as gases (e.g. air) and/or liquids (e.g. water), can be supplied, at least one of which is a motive fluid. Hose 110 passes through the hollow passage of narrow portion 606. The end of hose 110 is typically equipped with a coupling element, such as a metal fixture, which includes ports 501-505. The end of hose 110 is shown in phantom in FIG. 5B. As seen in FIG. 4, embodiments of the cap 220 preferably include threads 410 and a sealed terminus 420. The threads 410 are sized to screw into corresponding fittings on the air fitting 120. When a tool 130 is removed from its hose 110 and air fitting 120, the cap 220 can be screwed on in its place thereby preventing material from entering ports in the end of the hose and enabling the air fitting 120 to properly seat within the cradle and actuate the cradle switch. Embodiments further provide for an assembly 600 that includes a combined air fitting and cap, as seen in FIG. 6-8, that can function as a switch plug.

FIG. 6 depicts assembly 600 in a disconnected state that shows air fitting 120 disconnected from cap 220. Air fitting 120 includes a wide portion 602 with a length 604, a narrow portion 606 with a length 608 and a frustoconical portion 610 with a length 612. The length 604 of wide portion is at least long enough to accommodate the full length 616 of threads 410 of cap 220. The length 608 of narrow portion 606 is longer than the length 604 of wide portion 602. Such a difference in length helps to stabilize the assembly as it rests in the cradle.

Cap 220 includes terminus 420 with a length 614, a width 618 and threads 410 with a length 616 and a width 618a. In the embodiment depicted in FIG. 6, terminus 420 and wide portion 602 both have the same width 618 as such a configuration permits the assembly 600 to fit within a cradle and activate the cradle switch. If the terminus 420 is too large, the terminus may catch on the walls of the cradle and prevent activation of the cradle switch Therefore, the magnitude of width 618 is important to the operability of the assembly 600. In one embodiment, width 618 is nine sixteenth of an inch. Width 618a of threads 410, in FIG. 6, is smaller than the width 618 such that the threads fit within wide portion 602. The length 616 of threads 410 is, in one embodiment, less than the length of the corresponding threads 411 (see FIG. 5B) that are disposed on the inner wall of wide portion 602. Advantageously, this permits a single cap 220 to be used with more than one air fitting 120 without fear of the threads 410 bottoming out against the bottom of wide portion 602. In the embodiment depicted, the threads 411 are on the inner wall of the wide portion 602 while the threads 410 are on the outside of cap 220. In another embodiment, not shown, the threads 411 are on the outside of the air fitting while the threads 410 are disposed within a cavity of the cap. Referring again to FIG. 5B, a section of narrow portion 606 extends into the cavity 510 of wide portion 602. The ports 501-505 are disposed atop of this section.

Narrow end 606 is connected to wide end 602 by frustoconical portion 610 which gradually bridges the differing widths of the two ends. Frustoconical portion 610 engages the cradle such that the assembly 600 remains in the cradle and activates the cradle switch while preventing the assembly from falling out of the cradle.

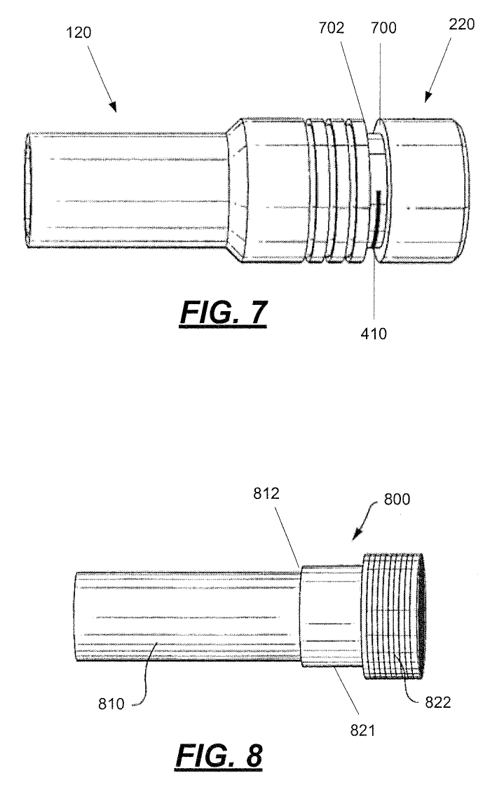

FIG. 7 is a depiction of assembly 600 in a partially assembled state. For the sake of illustration, cap 220 is not fully threaded into air fitting 120, thus threads 410 are still visible. When fully assembled, the ridge 700 of cap 220 is flush with the ridge 702 of wide portion 602.

FIG. 8 is a depiction of another embodiment of an assembly 800 that includes cap 822 that has been fully assembled by screwing cap 822 into wide portion 821. Wide portion 821 is connected to narrow portion 810. Unlike assembly 600, assembly 600 has a ridge 812 that prevents the assembly from falling out of the cradle, rather than a frustoconical portion.

Alternatively, a cradle switch plug, similar to that shown in FIG. 3, can include threads into which the cap 220 can be screwed so that when the user wishes to use the cap 220, he or she unscrews the cap 220 from the air fitting, then screws the cap 220 onto the air fitting end of the hose.

While various illustrative embodiments of the present invention described above have been presented by way of example only, and not limitation, it will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following clams.

What is claimed is:

1. A dental apparatus for delivering one or more fluids under pressure through a hose with an air fitting, the apparatus having a delivery unit cradle for holding the hose and wherein said cradle has a cradle switch operable to terminate the flow of fluid through the hose wherein the improvement comprises:
an air fitting sized to operate the cradle switch when disposed in the delivery unit cradle, the air fitting having a wall between two ends, at one end a wide portion with a first threaded portion, at the other end a narrow portion for connecting to the hose of the dental apparatus, and a connecting portion joining the wide portion to the narrow portion, the narrow portion having a width that is less than the width of the wide portion, the hose having at least two separate ports for transmitting fluids through the length of the air fitting;
a cap with a solid terminus at one end and a second threaded portion at the other end,
the solid terminus being equal to or wider than the second threaded portion; and
the second threaded portion having a width sufficient such that the second threaded portion engages the first threaded portion, thus connecting the cap to the wide portion.

2. The dental apparatus as recited in claim 1, wherein the length of the first threaded portion of the air fitting is longer than the length of the second threaded portion of the cap.

3. The dental apparatus as recited in claim 1, wherein the air fitting has at least five separate ports.

4. The dental apparatus as recited in claim 1, wherein the separate ports include a liquid supply port and a gas supply port.

5. A dental accessory comprising
an air fitting having a wall between two ends, at one end a wide portion with a first threaded portion, at the other end a narrow portion for connecting to a hose of a dental apparatus, and a frustoconical portion joining the wide portion to the narrow portion, the narrow portion having a width that is less than the width of the wide portion;
a hose with at least two separate ports for transmitting fluids through the length of the air fitting, the separate ports of the hose being discposed within the air fitting;
a cap with a solid terminus at one end and a second threaded portion at the other end,
the solid terminus being equal to or wider than the second threaded portion; and
the second threaded portion having a width sufficient such that the second threaded portion engages the first threaded portion, thus connecting the cap to the wide portion.

6. The dental accessory as recited in claim 5, wherein the first threaded portion of the air fitting is longer than the second threaded portion of the cap by a length of at least five millimeters.

7. The dental accessory as recited in claim 5, wherein the narrow portion of the air fitting is longer than the wide portion of the air fitting.

8. The dental accessory as recited in claim 5, wherein the air fitting has at least two separate ports for transmitting two different fluids through the length of the air fitting.

9. The dental accessory as recited in claim 8, wherein the separate ports include a liquid supply port and a gas supply port.

10. The dental accessory as recited in claim 5, wherein the air fitting has at least five separate ports.

11. The dental accessory as recited in claim 5, wherein the solid terminus and the second threaded portion of the cap are unitary.

12. The dental accessory as recited in claim 5, wherein the narrow portion, the wide portion and the frustoconical portion of the air fitting are unitary.

13. The dental accessory as recited in claim 11, wherein the narrow portion, the wide portion and the frustoconical portion of the air fitting are unitary

14. A dental accessory comprising
an air fitting having a wall between two ends, at one end a wide portion with a first threaded portion, at the other end a narrow portion for connecting to a hose of a dental apparatus, and a connecting portion joining the wide portion to the narrow portion, the narrow portion having a width that is less than the width of the wide portion;
a hose end, disposed within the air fitting, the hose end having at least two separate ports for transmitting fluids through the length of the air fitting,
a cap with a solid terminus at one end and a second threaded portion at the other end,
the solid terminus being equal to or wider than the second threaded portion; and
the second threaded portion having a width sufficient such that the second threaded portion engages the first threaded portion, thus connecting the cap to the wide portion.

15. The dental accessory as recited in claim 14, wherein the connecting portion is frustoconical.

16. The dental accessory as recited in claim 14, wherein the connecting portion has a ridge for seating the accessory in a dental cradle.

17. The dental accessory as recited in claim 14, wherein the first threaded portion of the air fitting is longer than the second threaded portion of the cap.

18. The dental accessory as recited in claim 14, wherein the wide portion defines a cavity and the threads of the first threaded portion are disposed on an inner wall of the cavity, the cavity being sized to receive the second threaded portion of the cap.
